(19) United States
(12) Patent Application Publication
(10) Pub. No.: US 2007/0216963 A1
(43) Pub. Date: Sep. 20, 2007

(54) Method And Arrangement For Imaging A Primarily Two-Dimensional Target

(76) Inventors: Zoltan Horvath, Budapest (HU); Tibor Virag, Budapest (HU)

Correspondence Address: YOUNG & THOMPSON, 745 SOUTH 23RD STREET, 2ND FLOOR, ARLINGTON, VA, 22202, US

(21) Appl. No.: 10/591,402

(22) PCT Filed: Mar. 3, 2005
(86) PCT No.: PCT/IB05/50789

§ 371 Date: Nov. 1, 2006

(30) Foreign Application Priority Data
Mar. 5, 2004 (HU) PO400533

(51) Int. Cl. H04N 1/195; H04N 1/04

(52) U.S. Cl. 358/474

(57) ABSTRACT

For imaging a two-dimensional target and ensuring scanning, photography and digitalization of the surface of a museum piece book opened at an angle slightly exceeding 45°, a method includes matching at least one optical unit adapted for influencing the direction of light rays falling onto it with the target, illuminating the target while directing an optical recording element to the optical unit and turning away the optical recording element, displacing in a receding manner from the plane of the target at a predetermined angle in a curved course compared to the optical axis originating from the target centre while tilting a mirror to half the extent of displacement, and mapping the pixels of the target reaching the optical recording element by projecting the rays originating from the pixels at right angles to the target through the optical unit to sensor elements.

### TECHNICAL FIELD

The invention relates to a method for imaging a primarily two-dimensional target, comprising the steps matching at least one optical unit adapted for influencing the direction of rays of light falling onto it with the target; illuminating the target while directing an optical recording means to the optical unit, mapping the pixels of the target reaching the optical recording means through the optical unit by projecting the rays originating from the pixels of the target at right angles to the target through the optical unit to sensor means of the optical recording means in the whole range of the optical angle of the optical recording means. The invention relates further to an arrangement for imaging a primarily two-dimensional target, including at least one optical unit adapted for influencing the direction of rays of light falling onto it, a light source illuminating the target and optical recording means directed to the optical unit, the arrangement ensures scanning, photography and digitalization of the whole surface of the book-pages in a way that the book needs to be opened at a relatively little angle of slightly exceeding 45°.

### BACKGROUND ART

Photography and microfilming were already used for recording data in the traditional library and archive practice. The up-to-date digital data recording has increased the need for these methods. A great number of different high-speed scanners are used for the digitalization of individual pages and books. However, they have only a limited use in connection with the processing of expensive books of museum piece, since in this case the books should be opened in at least 90° or in many cases even in 180°. This forced opening might damage both the cover and the pages. According to one of the known solutions the page to be photographed is not completely flattened but some waving is tolerated. The resulting mapping or exposure distortions are corrected by software means.

US 2002/191,994 discloses scanning by way of a one-dimensional sensor. One disadvantage of this solution is that the scanning is carried out by the movement of the sensor or the imaging system, which makes it slow and on the other hand, the scanning of the details falling close to the spine of the book is not properly worked out.

A truly quick scanning method corresponding to photography is disclosed in CN 1,354,441. However, it fails to describe the scanning and the required homogenous illumination in case of books and other documents with similarly limited opening angle.

Theoretically there are three ways of digitalization of two-dimensional images, more specifically book pages.

In case of the first alternative the information content of the individual image pixels are recorded sequentially one-by-one. Due to its slowness this method is not used for the digitalization of books, but it plays an important role in the con-focal laser microscopes or in the CD/DVD readers operating based on the same theoretical background.

In case of the second alternative a one-dimensional inline sensor is moved along at right angles to the surface of the object, i.e. to the target and the image is than composed from the lines recorded this way. The operation of most of the photocopiers and some of the scanners is based on this principle. U.S. Pat. No. 4,585,334; U.S. Pat. No. 4,633,080; U.S. Pat. No. 6,603,580; U.S. Pat. No. 5,012,275; CS 2,253,522 or U.S. Pat. No. 6,587,227 show such types of equipment and methods. One of the drawbacks of this principle is that the design of the linear sensor itself, the joint illuminating solution and the required moving mechanism does not provide for the proper scanning of the spine adjoining parts, not even at an opening angle of 90°. Although great efforts have been made to improve these features for several decades, no useful results have been gained to day. The latest scanner generation is equipped with so-called LIDE sensors, where the illuminating LEDs, the sensor units and the optics are integrated on a single semiconductor tape. However, even this sensor is incapable to come closer than 10 mm to any obstacles protruding out of the plane of the scanning i.e., the opened page of a book. In case of each above-mentioned solution based on one-dimensional image receiving units the books should be opened at least at right angles and no mention is made concerning the extent of the blank space close to the spine of the book which remains inaccessible to scanning.

The third solution is when the surface to be digitized is fully projected to the sensor, the classical application of which having been the microfilming. Of course several solutions were developed to improve this method in the last century. Now the proposed solutions can directly be taken over to the field of digital photography. With the rapid enlargement of the sensors and the resolution of the two-dimensional CCD and CMOS optical sensors this third solution will be the dominant one in this filed.

Similar equipment and solutions are introduced by the documents provided by Palo Alto Research Centre, U.S. under the title ‘Bookscanner’, by the product ‘OMNISCAN 3000’ of the company Zeutschel, Germany, or the product ‘PageScan 150’ of Reality Imaging Systems Co., U.S., to mention only some examples. It is unfavourable that here there are also only limited opportunities to open the books less than at right angles. Considering the importance of this issue these scenarios will be separately detailed underneath.

The ‘Bookscanner’ of Palo Alto Research Centre is a typical solution for the 90° opening. Here a book opened at right angles and lying on its back is photographed and digitized from above, from the right and from the left at an angle of 45° i.e. at right angles to the pages themselves. It might be misleading that the repeatedly mentioned 45° here means the lifting angle of the individual sides i.e. pages of the opened book lying on its back. Consequently, in the light of this interpretation a 0° angle on both sides means a completely—at an angle of 180°—opened book, while a 45° lifting on both sides means a book opened at an angle of 90°. But the question still remains: how can it be solved that the book is to be opened at the least possible angle, yet its pages could be photographed as far as the spine of the book.

A theoretically perfect solution of this problem is presented by the method described in U.S. Pat. No. 5,359,207. Here there is a thin sensor of the size of a book-page laid between the pages, which also contains the illumination and the sensor units. The minimal thickness of the sensor makes an opening of the smallest angle possible. The only problem is that according to our knowledge an optical sensor of such thickness still does not exist.

An optically perfect solution can be found in a document under the title ‘The Unique Prism Camera System’ describing the apparatus ‘OK301P’ of OMNIA. Here a solid optical prism of 60° solves the problem of viewing the full 180° image of a book opened at 60°. The upper surface of the prism can be considered as a simple window, but the two lower parts fulfill a twofold job simultaneously. The left-side surface is a window from the perspective of the left-hand book-page, since the light goes thorough it at nearly right angles with a minimal loss. But from the perspective of the right-hand book-page it behaves like a total reflection mirror, since the light—coming from the optically thicker medium i.e. from the centre of the prism—falls to it at 60° angle of incident, thus sending the image towards the camera acting as an image recording means. The right side surface of the prism has a similarly twofold role. These two surfaces work similarly with respect to the illumination. The optical mirror has been used in small scale for a hundred years in the ray distributors of the binocular microscopes and in certain telescopes to reverse the reversed images. When considering this solution it should be kept in mind that the 60° angle is a theoretical value since there is no way of modifying or reducing it. On the other hand, the prism itself should be made of material having much higher rate of refraction coefficient than that of the air (glass, fibreglass, transparent fluid, etc.). In case of an A3 book-page the edge length of the prism should be at least 600 mm with at least 420 mm height. It is extremely difficult to manufacture such a prism of the required optical homogeneity and quality (the lens and mirror basic material of the astronomical telescopes fall into this dimensional range, the cooling process of which lasts for years in order to eliminate tensions occurring during the manufacturing process). The quantity of the prism also would be considerable with its weight of 100 kg. Further application problem arises with the condition that the surface of the prism can fulfill its twofold role only if it is completely clean and free from any contacts. The sensitivity of this situation can be seen from the application of such total reflection prisms at the footprint scanners for detecting: the total reflection ceases at the points where the skin wrinkles contact the glass which results in extremely hard-contrast images.

GB 2,292,281 presents a solution where the book should be opened at an angle of 45° in case of overhead illumination. However, the description neither refers to its effective feasibility nor suggests what is there in the described wedge. Presumably a mirror positioned at an angle of 45° is applied. But, according to our experiments and experiences in case of a camera positioned at a finite distance, harmful reflections occur between the mirror and the glass pressing down the page, which hinder taking good quality images.

### DISCLOSURE OF INVENTION

### Technical Problem

The problems and reflections arising out of the illumination can be considered as common drawbacks of the known solutions and with our invention it is one of our main goals to eliminate such reflections.

A further goal is to facilitate the good quality scanning of mechanically sensitive documents such as old books and similar object with opening them at the least possible angle.

Advanced optical designing programs include so called ‘ghost focus generator’ modules to analyze the effects of the harmful reflections, but they are not suitable for analyzing ghost images created on plane-mirrors.

### Technical Solution

The core idea of our invention is the realization that with the proper setting of the angle of the camera and the mirror an optical arrangement can be created which evades these harmful optical reflections while mainly preserves the beneficial characteristic of the above mentioned mapping system in view of scanning books, namely the fact that the page of the book can be seen as far as nearly the spine even at small opening angle.

The present invention is based on the recognition that it would be enough to open the book only at an angle of 45° or smaller, if we could turn the course of the light preferably without distortion by means of a mirror placed into the book. But the page to be photographed should at any rate be pressed down in order to keep it in the focal level of the camera. This pressing-down tool or eventually the gleaming book page may cause secondary reflections which appear in the image as shady ghost images of the page or the light source. The reflection of the pressing plate can be reduced by suitable coating, but in this case it is technically impossible to reduce it below the required level of 0,1%, not to mention the impossibility of modifying the optical parameters of the scanned object i.e., the page of the book.

Our proposed solution to the objective set above is based on a method for imaging a primarily two-dimensional target, comprising the steps matching at least one optical unit adapted for influencing the direction of rays of light falling onto it with the target;

illuminating the target while directing an optical recording means to the optical unit, mapping the pixels of the target reaching the optical recording means through the optical unit by projecting the rays originating from the pixels of the target at right angles to the target through the optical unit to sensor means of the optical recording means in the whole range of the optical angle of the optical recording means. The novelty of this method is that the optical recording means is turned away and displaced in a receding manner from the plane of the target at a predetermined angle in a curved course compared to the optical axis starting from the centre of the target while the mirror is tilted half to the extent of the displacement of the optical recording means.

According to one advantageous implementation of the proposed method the imaging comprises the step of pressing down the surface of the target to gain flat surface for mapping.

It is also advantageous according to the present proposal to choose the value of the angle α exceeding at least the half of the optical angle of the optical recording means.

It is furthermore advantageous according to the present proposal that the matching comprises the step of using a surface mirror.

According to another advantageous implementation of the proposed method a wedge-shaped optical element composed of a pressing-down glass plate and a surface mirror is used.

According to another advantageous implementation of the proposed method an optical element with adjustable front rake is used.

It is furthermore advantageous according to the present proposal the scanning comprises the step of scanning both pages of the opened book used as the target consecutively by a mirror embedded into the wedge-shaped element so that it can be tilted, but without removing the wedge-shaped element from between the glass plates constituting its boundaries.

According to another advantageous implementation of the proposed method a light source providing homogenous diffused light is used.

It is furthermore advantageous according to the present proposal if said light source is assembled of several discrete light sources.

On the other hand, the objective set above has been solved by an arrangement for imaging a primarily two-dimensional target, including at least one optical unit adapted for influencing the direction of rays of light falling onto it, a light source illuminating the target and optical recording means directed to the optical unit, wherein while being directed to the optical unit the optical recording means is positioned in a way that it is turned away and displaced in a receding manner from the plane of the target at a pre-determined angle in a curved course compared to the optical axis originating from the centre of the target and originally running at an angle of 45° to the surface of the target, while the mirror is tilted to a rate which is increased by a half of the displacement angle of the optical recording means.

### Advantageous Effects

The major advantages of the proposed method are that, firstly, it enables the scanning of physically sensitive documents of limited movability i.e. old books and codices in a way that they are to be opened at an angle of much less than 60° while offering a scanned image of practically free from distortions and even more importantly, from reflections and ghost images. The proposed method and arrangement is less stereoscopic so it can also be applied for mapping and scanning 3D type objects without any further auxiliary measures.

### DESCRIPTION OF DRAWINGS

Features and advantages of the invention will be apparent from the following description of preferred embodiment, given for the purpose of disclosure and taken in conjunction with the accompanying drawings wherein

FIGS. 1A, 1B show the theoretical diagram of the course of light of the reflected image of a target on the focal plane of a camera acting as optical recording means in real and developed perspective;

FIGS. 2A, 2B show the reflected image of a target recorded with a prior art method;

FIGS. 3A, 3B show the reflected image of an object in real and developed perspective according to the proposed invention;

FIG. 4 shows a possible embodiment of an arrangement effecting the proposed method; and

FIG. 5 shows a schematic diagram of the arrangement of FIG. 4 applied for two-page scanning.

### BEST MODE

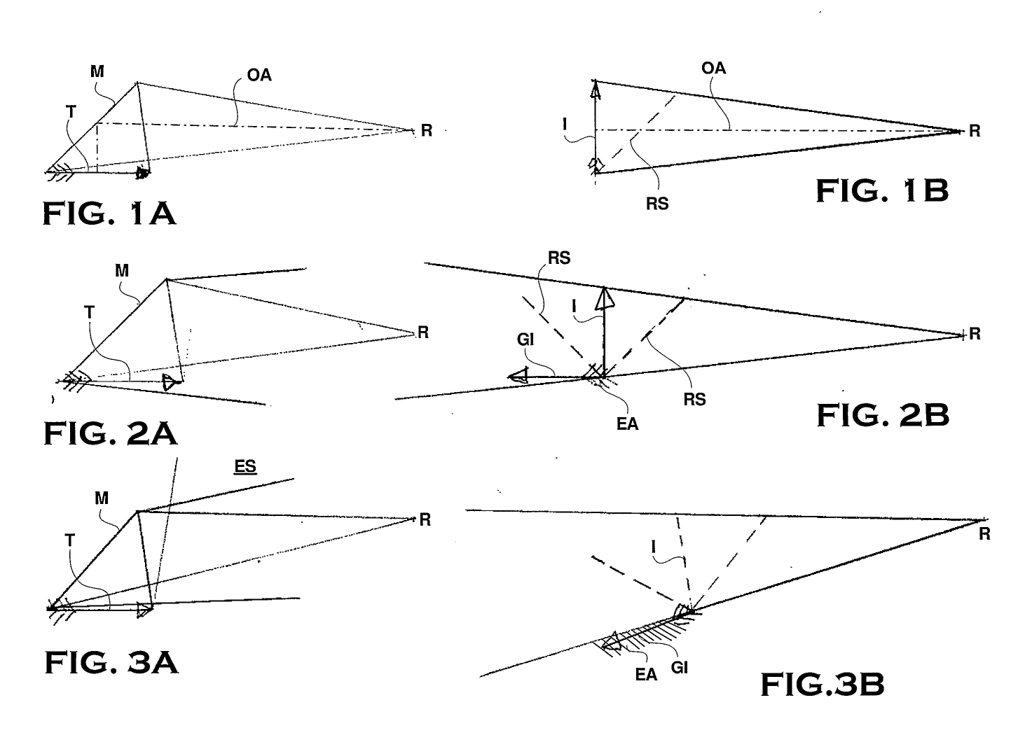

FIG. 1A shows a well-known basic situation. It is assumed, that target T represented by an arrow is not reflective and image I is transferred to a point R representing an optical recording means e.g. a camera by means of mirror M positioned on a plane extending in an angle of 45° to the plane of target T.

FIG. 1B shows a developed light path. In fact, this is the way how a camera or the human eyes see the image. The dotted line represents the at least one reflecting surface which can not be seen from point R (i.e. from the position of the camera). The target T to be imaged should be positioned in a way that an axis OA of the imaging originated from point R and refracted on intermediate reflecting surfaces RS finally passes through the focal point of the target T while being at right angles to its surface. This arrangement ensures an imaging of the least distortion.

FIG. 2A shows a variant of the above arrangement wherein even target T itself (or the pressing-down element i.e. glass) is reflective. FIG. 2B shows that the mapped image I of target T is at the same place like in FIG. 1B but here there is also a ghost image GI below as a result of the threefold reflection (it is reflected twice on mirror M and in the meantime once on its own gleaming reflected surface RS, see the dotted lines). The shaded area represents empty areas EA excluded from the field of vision. It should be noted that the ghost image GI appearing as a vague and flat image of target T under its real image I falls fully within the field of vision.

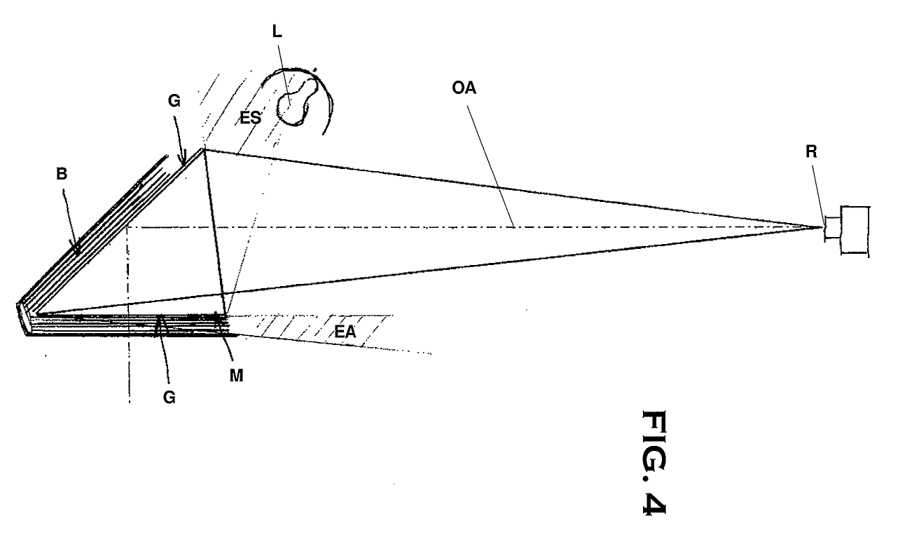

FIGS. 3A and 3B show a scenario where the point R representing the camera is displaced form its usual position as seen in the previous Figures in a way that it is displaced and turned away upward in a curved course to the direction marked in the Figure at an angle α compared to the optical axis OA originating from the focal point of target T so that the optical axis OA passes through the focal point of target T at right angles to its surface even in this case, and the mirror M should also be tilted with half of the angle (α/2) of the displacement of point R.

It can be seen that the ghost image GI being the result of the manifold reflections now falls to the shaded empty area EA, i.e. outside the field of vision of the optical recording means, e.g. camera.

In case the point R representing the camera is displaced to the opposite direction compared to the optical axis OA originating from the focal point of the target T (downwards according to the Figure), ghost image GI will fall even more within the field of vision, so this option can and should be ignored.

Consequently, if the optical recording means is displaced upwards compared to the optical axis OA positioned at a theoretical angle of 90° in FIG. 1A with an angle α corresponding to half of the visual angle of the camera, while in order to retain the right angle perspective the mirror M is displaced from the theoretical angle of 45° with an angle corresponding to the half of the angle α of the above-mentioned displacement, then the targets requiring strong illumination and their reflected (and manifold reflected) virtual images will fall out of the field of vision of the camera, while areas S which can be held dark with known measures, will fall within, so they will not disturb the image I. Moreover, with the angles of vision practically used by this arrangement an empty space ES is created, the image of which is never brought into the field of vision of the camera by any initial or superior reflections, and the illuminating light sources can be optionally placed, (see FIG. 4). Through their proper setting a homogeneous illumination can be provided.

There are several practical options to implement the above-described solution. In the simplest case an arrangement can be set up which enables to scan and image the target T, e.g. one page of an opened book, by means of assembling a pressing glass plate G and a surface mirror M at the proper angle and of the proper placement of the camera as well as the light sources and by means of covering the spaces which are sensitive from the point of view of ghost image creation with some dark material.

FIG. 4 shows one of the preferred embodiments. Calculating with the parameters of a commercially available photo camera (e.g., Lecia) in case of a lens with a focal distance of 80 mm the total length of the optical way required by taking a image of an A4 page is 700 mm where the angle of vision of the objective is 17°. Based on the above-mentioned considerations the point R of the camera should be raised by at least α=8,5° compared to the optical axis OA extending at right angles to the surface of target T. In fact, the use of a somewhat bigger angle, e.g. α=10° is recommended. In this case the mirror M should be tilted upwards with an angle of 5°. In this arrangement a book corresponding to target T should be opened only at an angle of 50° which means a substantially more tolerant handling from the point of view of the book. With the proper selection of the camera, when the above-mentioned considerations are also taken into respect, the opening angle of the book can be further reduced, which rate is constrained only be the physical dimensions of the mirror M to be inserted between the pages of the book.

According to a further preferred implementation the book intended to be scanned is placed onto the surface of a wedge-shaped unit, where one of its sides is a pressing-down glass plate G, while the other is the mirror M.

Let us suppose that the thickness of both mirror M and the pressing-down glass plate G is 3 mm. It can be easily calculated that in this case the parts of target T situated at 6 mm inwards from the outer edge of the wedge formed by M and G will already appear on the scanned image I.

Since there is only one mirror M placed in the course of light, the image I will be reversed compared to target T, but with the modern digital processing systems it can be easily corrected by some software or hardware solutions.

The basic material of the pressing-down glass plate G and mirror M can be plane-parallel optical glass of the type BK7 but some better quality float (window) glass is also suffice. Mirror M is preferably a surface mirror with its reflecting layer situated on the external face of the basic glass plate. Such mirrors widely used at optical applications are produced and dressed e.g. by Unioptik Ltd., Hungary. By this solution those ghost images can be eliminated resulted by the reflection on the face of the nonsurface mirror which would appear in the same size like the original but shifted by 1-2 mm off depending on the thickness of the glass of the mirror M.

The objective is required by all means since it is what enables the mapping of the pixels to the image receiving sensor. For this purpose an appropriate version of the Rodenstock Rodagon series (they are available with different focal distances) or that of the Schneider Company, Germany (Home page: http://www.schneider-kreuznach.com) can be used.

Two main types of the image receiving sensors can be used (beside the classic film): CCD and CMOS sensors. An upgraded version of the latter is the type ‘X3’ of the Foveon company.

The illumination should be set according to the experience. The Figures may provide help in identifying those empty spaces ES which do not fall within the field of vision of the camera even after repeated reflections. To gain homogenous illumination it is recommended to use several light sources L with big lighting surface and providing diffused light, similarly to the known solutions applied by the reproduction technologies.

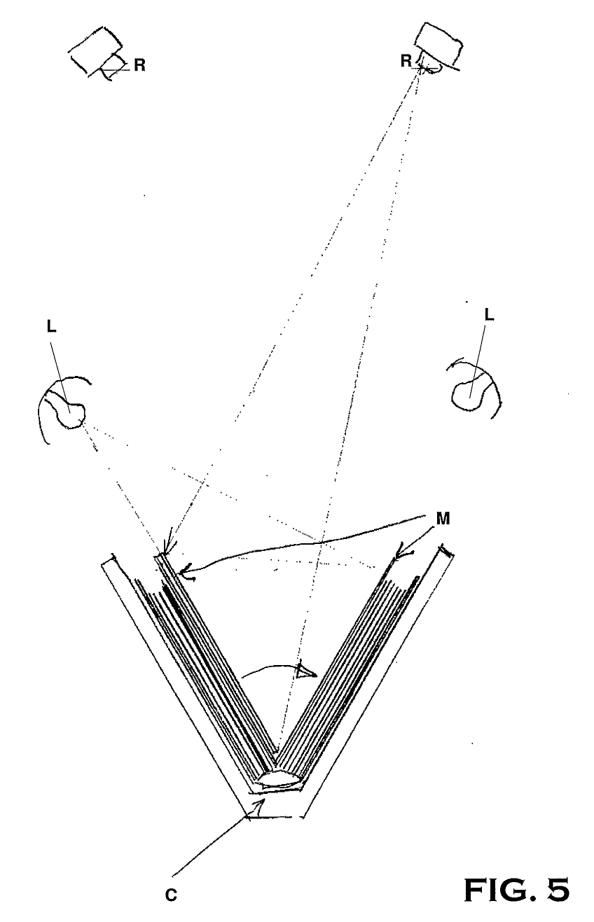

In general, when digitizing books, both the left-hand and the right-hand pages are needed. When scanning sensitive books it can be a big advantage if both pages can be photographed from the same position without the book having to be moved. The proposed new method and arrangement make this possible as shown in FIG. 5.

In this case book B is placed into a self-aligning cradle C with an open top and parallel edges, the opening angle of which corresponding to that of the proposed mapping arrangement. The frontal part of this arrangement, which is a wedge-shaped unit consisting of two glass plates G set at an angle corresponding to the opening angle, fits into the opened book B from above, thus smoothing down both of the pages. The surface mirror M, coated on both sides and embedded so that it can be tilted and turned, is situated in the interior of the wedge, practically close to its lower edge. The illuminating L light source which can be implemented as a group of light-sources as well, and two cameras are fixed symmetrical above the book B. With the mirror M tilted to the left we the image of the right page can be taken with the camera on the right using the L light source on the left, than, after tilting the mirror M to the opposite position and using the symmetrical elements the image of the left page can be taken. After the wedge-shaped unit is lifted, the page will be turned and the procedure will continue with the next pair of pages. The tilting of mirror M can be done by hand or by way of an operating device.

The two cameras can be replaced by a single one, moving simultaneously with mirror M but to the opposite direction. Moreover, the camera can also be fixed, if diverting the light to the required direction by means of other known optical units (they are not shown in the Figure), which move simultaneously with the tilted mirror M.

In another preferred embodiment of the proposed arrangement the complete optical unit is fixed, while the cradle C holding the book B goes up and down. The horizontal position of the cradle C with the open top is practical to be maintained since it facilitates turning the pages.

According to another preferred embodiment of the proposed arrangement the cradle C holding the book B is fixed while the optical unit moves up and down.

According to another preferred embodiment the wedge-shaped element of the optical unit can be turned in 180° on a central vertical rotation axis, while the glass plate G and the mirror M change places, and when the wedge-shaped element is sunk down, the other page of the book B can be scanned using the mirror G. The main advantage of this solution is that by means of a single wedge-shaped element both of the pages can be scanned without moving the book B.

Although it is less favorable from financial point of view, the optical unit can be doubled so that the mirror G is placed into one of the part-units on the one side while the other is placed into the other part-unit on the other side and the cradle C with the opened book on it moves horizontally here and there under the two part-units. The main advantage of this solution is that the optical part-units need to be movable only along the vertical track, thus enabling preservation of the settings which proved to be favorable.

Of course, this arrangement can be reversed in a way where the optical unit is situated underneath while the book B is placed onto the wedge-shaped element facing upwards, where the necessary smoothness of the pages is ensured by the own weight of the book B.

As a result of the latest technical developments another preferred embodiment can also be implemented, where both sides of the wedge-shaped element consist of controllable plates, which depending on the nature of the control sign behave as completely transparent or completely reflecting elements. With this solution the need for applying moving parts (surface mirror Ms on both sides) in the wedge-shaped element can be eliminated for scanning two pages simultaneously.

Naturally the process of turning the pages can also be automatically controlled by means of known technology used in the printing or copying technology.

The proposed method and arrangement also allow for scanning watermarks. For this purpose a thin (0,1-5,0 mm) and practically two-dimensional homogenous illuminating device, such as the electroluminescent sources of light used for the background illumination of TFT displays can be used.

It should be understood, however, that the description herein of specific embodiment is not intended to limit the invention to the particular forms disclosed, but on the contrary, the intention is to cover all modifications, equivalents, and alternatives falling within the spirit and scope of the invention as defined by the appended claims.

1. A method for imaging a primarily two-dimensional target (T), comprising the steps matching at least one optical unit adapted for influencing the direction of rays of light falling onto it with the target (T); illuminating the target (T) while directing an optical recording means to the optical unit, mapping the pixels of the target (T) reaching the optical recording means through the optical unit by projecting the rays originating from the pixels of the target (T) at right angles to the target (T) through the optical unit to sensor means of the optical recording means in the whole range of the optical angle of the optical recording means, characterized by turning away the optical recording means and displacing in a receding manner from the plane of the target (T) at a predetermined angle α in a curved course compared to the optical axis (OA) originating from the centre of the target (T) while tilting a mirror (M) half to the extent of said displacement i.e. with an angle α/2 of the optical recording means.

2. A method according to claim 1, characterized by pressing down the surface of the target (T) to gain flat surface for mapping.

3. A method according to claim 1 characterized by choosing the value of the angle α exceeding at least the half of the optical angle of the optical recording means.

4. A method according to claim 1, characterized by using a mirror (M) as the optical element.

5. A method according to claim 4, characterized by using a surface mirror (M).

6. A method according to claim 1, characterized by using a wedge shaped optical element composed of a pressing-down glass plate (G) and a surface mirror (M).

7. A method according to claim 6, characterized by using an optical element with adjustable front rake.

8. A method according to claim 1, characterized by scanning both pages of the opened book (B) used as the target (T) consecutively by a mirror (M) embedded into the wedge-shaped element so that it can be tilted, but without removing the wedge-shaped element from between the glass plates (G) constituting its boundaries.

9. A method according to claim 1, characterized by applying a light source (L) providing homogenous diffused light.

10. A method according to claim 9, characterized by applying a light source (L) assembled of several discrete light sources.

11. An arrangement for imaging a primarily two-dimensional target (T), including at least one optical unit adapted for influencing the direction of rays of light falling onto it, a light source (L) illuminating the target (T) and optical recording means directed to the optical unit characterized in that while being directed to the optical unit the optical recording means is positioned in a way that it is turned away and displaced in a receding manner from the plane of the target (T) at a predetermined angle α in a curved course compared to the optical axis (OA) originating from the centre of the target (T) and originally running at an angle of 45 to the surface of the target (T), while a mirror (M) is tilted to an extent which is increased by a half of the displacement angle- i.e. with an angle α/2 of the optical recording means.

12. A method according to claim 2, characterized by choosing the value of the angle α exceeding at least the half of the optical angle of the optical recording means.

13. A method according to claim 2, characterized by using a mirror (M) as the optical element.

14. A method according to claim 2, characterized by using a mirror (M) as the optical element.
